(19) United States
(12) Patent Application Publication
(10) Pub. No.: US 2014/0099151 A1
(43) Pub. Date: Apr. 10, 2014

(54) Marking Enhancement Device

(71) Applicants: SHAZAM ABDUL, Kissimmee, FL (US); Savitrie Abdul, Kissimmee, FL (US)

(72) Inventors: SHAZAM ABDUL, Kissimmee, FL (US); Savitrie Abdul, Kissimmee, FL (US)

(21) Appl. No.: 13/646,689

(22) Filed: Oct. 6, 2012

(51) Int. Cl. B43K 23/008

(52) U.S. Cl. 401/6

(57) ABSTRACT

A marking enhancement device for facilitating and enhancing markings and helping to adjust writing styles. The device positions over a marking device in proximity to where a hand grasps. The device counteracts the pressure exerted by the hand while marking. The device includes a shaft portion for receiving the marking device. The shaft portion includes an aperture through which the marking device passes through. At least one lever joins along a longitudinal axis of the shaft, and extends outwardly from the shaft. Each lever includes a U-shape configured to be grasped by the hand while marking. A tension portion, such as a coil spring, positions between the shaft and the each lever. The tension portion provides a compressive force that counteracts the pressure applied on the marking device during marking. In this manner, the pressure transfers from the marking device and the marking surface to the tension portion.

### CROSS-REFERENCE TO RELATED APPLICATIONS

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to writing instruments. More particularly, one or more embodiments of the invention relate to enhancing writing styles with writing instruments.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a pencil is a writing device usually constructed of a narrow, solid lead core inside a protective casing. The case prevents the core from breaking, and also from marking the user's hand during use. Pencils create marks via physical abrasion, leaving behind a trail of solid core material that adheres to a sheet of paper or other surface. Pens, which are similar, dispense liquid or gel ink that stain the light color of the paper.

Typically, handwriting is a particular and individual style of writing with pen or pencil. Handwriting is distinct from “hand” or script which is any impersonal and formalized writing style in several historical varieties.

Typically, pencil or pen attachments may assist the proper placement of fingers while writing. The proper placement and pressure applied to the pencil may enhance the writing style.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a frontal view of an exemplary marking enhancement device, in accordance with an embodiment of the present invention;

FIG. 2 illustrates a frontal view of an exemplary marking enhancement device positioned on an exemplary marking device, in accordance with an embodiment of the present invention;

FIG. 3 illustrates a frontal view of an exemplary marking enhancement device being held by an exemplary hand, in accordance with an embodiment of the present invention;

FIG. 4 illustrates a frontal view of an exemplary marking enhancement device receiving pressure device from an exemplary hand, in accordance with an embodiment of the present invention; and

FIG. 5 illustrates a detailed perspective view of an exemplary marking enhancement device without at least one tension portion, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived there from.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of marking enhancement devices that may be provided by preferred embodiments of the present invention. In one embodiment of the present invention, the marking enhancement device may be configured to facilitate and enhance markings and help to adjust a style of performing markings with a marking device. The marking enhancement device may position over the marking device in proximity to where a hand may grasp the marking device. The marking enhancement device may counteract the pressure exerted by a hand, thereby minimizing pressure on a marking surface. In some embodiments, the marking enhancement device may be configured to be operable to inhibit a tight grasp of the marking device. In this manner, the marking enhancement device may be configured to absorb excessive pressure and grasping force exerted by the hand. The marking enhancement device may also be efficacious in minimizing forceful presure on a marking surface, thereby decreasing fatigue in the fingers and a hand. Those skilled in the art, in light of the present teachings will recognize that inhibiting a tight grasp of the marking device may enhance the markings and help to adjust the style of performing markings. Further, inhibiting a tight grasp of the marking device may eliminate fatigue in the hand and the fingers. For example, without limitation, a user with Parkinson disease may develop a steadier, more consistent writing style through utilization of the marking enhancement device. The positioning and outward pressure exerted by the marking enhancement device may also help to enhance a writing style, thereby decreasing sloppy handwriting. The marking enhancement device may be efficacious in decreasing the pressure applied on the marking device, and consequently a marking surface, by transferring the pressure from the marking device to the marking enhancement device. In yet another embodiment, the marking enhancement device may help to promote a tripod grasp while marking with the marking device.

In one embodiment of the present invention, the marking enhancement device may include a shaft portion configured to cover the marking device. The shaft portion may include an aperture. The aperture may be configured to at least partially allow the marking device to pass through. In some embodiments, the shaft portion may move and adjust along a longitudinal axis of the marking device. Those skilled in the art, in light of the present teachings will recognize that myriad marking styles and hand sizes may require the marking enhancement device to be adjusted to accommodate a desired point along the marking device.

In one embodiment of the present invention, at least one lever may join in proximity to the aperture of the shaft portion, and extend outwardly from the shaft portion. The at least one shaft portion may align substantially parallel along a longitudinal axis of the shaft portion. The at least one lever may include a U-shape and be configured to be operable to be grasped by the fingers while marking. In this manner, the marking device may not be engaged by the fingers while marking. In some embodiments, the shaft portion and the at least one lever may form a unitary device. In another embodiment, the at least one lever may include two levers joined to both ends of the shaft portion, and form a half-circle shape. However other shapes and dimensions may be utilized for the at least one lever.

In one embodiment of the present invention, at least one tension portion may position between the shaft portion and the at least one lever. The at least one tension portion may provide tension for pressing outwardly against the fingers or hand. The at least one tension portion may position at an opposite end of where the shaft portion and the at least one lever join. In some embodiments, the at least one tension portion may provide a compressive force that counteracts the pressure applied on the marking device during marking. In this manner, the pressure may transfer from the marking device and the marking surface to the at least one tension portion.

The embodiment may be presented with a different design, but works the same way. In one embodiment, the marking enhancement device may include a shaft, wherein each lever may join with both end of the shaft portion, and extend outwardly from the shaft portion. In some embodiments, the thickness of the at least one lever may determine each lever's strength. In this manner, a thicker, more flexible at least one lever may eliminate the necessity of the tension portion.

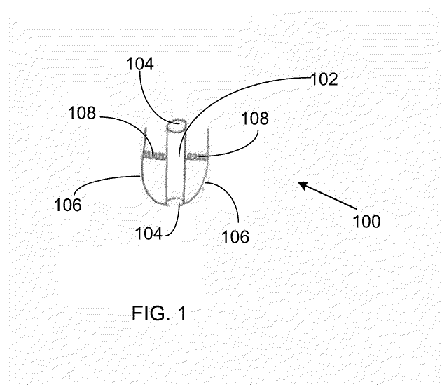

FIG. 1 illustrates a frontal view of an exemplary marking enhancement device, in accordance with an embodiment of the present invention. In the present embodiment, the marking enhancement device 100 may include a shaft portion 102 configured to enable the marking device to at least partially pass through the shaft portion. The shaft portion may be configured to form an aperture 104 through which the marking device may pass through. In some embodiments, the shaft portion may move and adjust along a longitudinal axis of the marking device. Those skilled in the art, in light of the present teachings will recognize that myriad marking styles and hand sizes may require the marking enhancement device to be adjusted to accommodate a desired point along the marking device.

In one embodiment of the present invention, at least one lever 106 may join in proximity to the aperture of the shaft portion, and extend outwardly from the shaft portion. The at least one lever may include a U-shape and be configured to be operable to be grasped by the fingers while marking. In this manner, the marking device may not be engaged by the fingers while marking. The at least one lever may include two separate levers configured to conform to the fingers. However in other embodiments, additional levers may be utilized. In some embodiments, the shaft portion and the at least one lever may form a unitary device. The positioning of the at least one lever may serve to minimize forceful presure on a marking surface, and thereby decrease fatigue in fingers and a hand. The positioning and outward pressure exerted by the at least one lever may also help to enhance a writing style, thereby decreasing sloppy handwriting. Suitable materials for the marking enhancement device may include, without limitation, plastic, high density polyurethane, polyvinyl chloride, silicone, rubber, aluminum, and metal alloys.

In one embodiment of the present invention, at least one tension portion 108 may position between the shaft portion and each lever. The at least one tension portion may position at an opposite end of where the shaft portion and the at least one lever join. In some embodiments, the at least one tension portion may provide a compressive force that counteracts the pressure applied on the marking device during marking. In this manner, the pressure may transfer from the marking device and the marking surface to the at least one tension portion. In some embodiments, the at least one tension portion may include numerous different compression forces, including, without limitation, light, medium, and strong. Suitable designs for the at least one tension portion may include, without limitation, a metal coil, a plastic coil, and a slidable metal component.

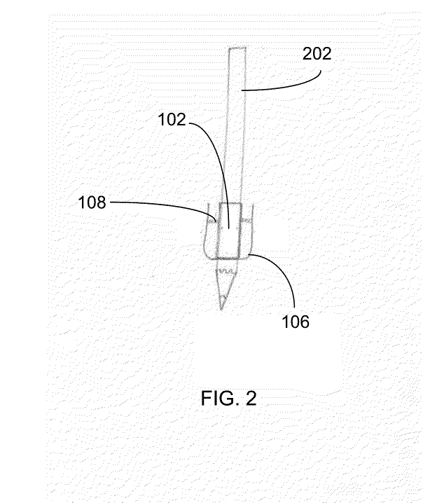

FIG. 2 illustrates a frontal view of an exemplary marking enhancement device positioned on an exemplary marking device, in accordance with an embodiment of the present invention. In the present embodiment, the marking enhancement device may position over the marking device 202. The marking enhancement device may be interchangeable to position over variously sized marking devices. In some embodiments, the shaft portion may include an adjustable circumference to conform to various sizes and styles of marking devices. In one alternative embodiment, the marking enhancement device may be oriented with the aperture in greater proximity to the marking surface, or reoriented to be a greater distance from the marking surface.

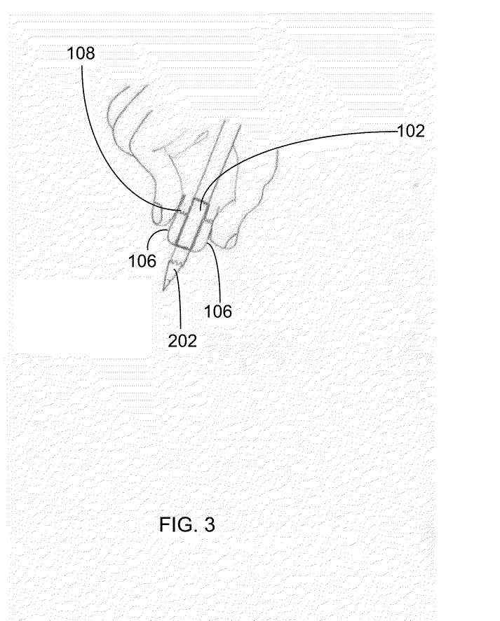

FIG. 3 illustrates a frontal view of an exemplary marking enhancement device being held by an exemplary hand, in accordance with an embodiment of the present invention. In the present embodiment, the marking enhancement device may be configured to facilitate and enhance markings and help to adjust a style of performing markings with a marking device. The marking enhancement device may position over the marking device in proximity to where a hand may grasp the marking device. The marking enhancement device may adjust along the longitudinal axis of the marking device.

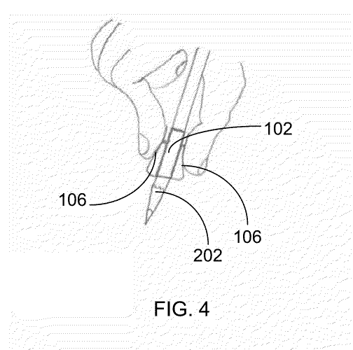

FIG. 4 illustrates a frontal view of an exemplary marking enhancement device receiving pressure device from an exemplary hand, in accordance with an embodiment of the present invention. In the present embodiment, the marking enhancement device may be configured to be operable to inhibit a tight grasp of the marking device. In this manner, the marking enhancement device may be configured to absorb excessive pressure and grasping force exerted by the hand. Those skilled in the art, in light of the present teachings will recognize that inhibiting a tight grasp of the marking device may enhance the markings and help to adjust the style of performing markings. Further, inhibiting a tight grasp of the marking device may eliminate fatigue in the hand and the fingers. The marking enhancement device may be efficacious in decreasing the pressure applied on the marking device, and consequently a marking surface, by transferring the pressure from the marking device to the marking enhancement device. For example, without limitation, the marking enhancement device may include a measurable tool for professionals including, without limitation, therapist, teachers, and parents to use with a child, and to determine if the child's proprioceptive input and handwriting skills are improving. The pressure applied to the at least one tension portion may be observed to study how the child initially marks, and how much pressure the child may be using in a few weeks or months later. In this manner, the child may initially exert high pressure on the marking enhancement device at the beginning of a school semester. Yet, as the school year progresses, the child may decrease from a high pressure on the marking enhancement device to a medium pressure. The professional may then modify the marking style of the child by the ending of the school year to a soft pressure, or elimination of the marking enhancement device. In yet another embodiment, the marking enhancement device may help to promote a tripod grasp while marking with the marking device.

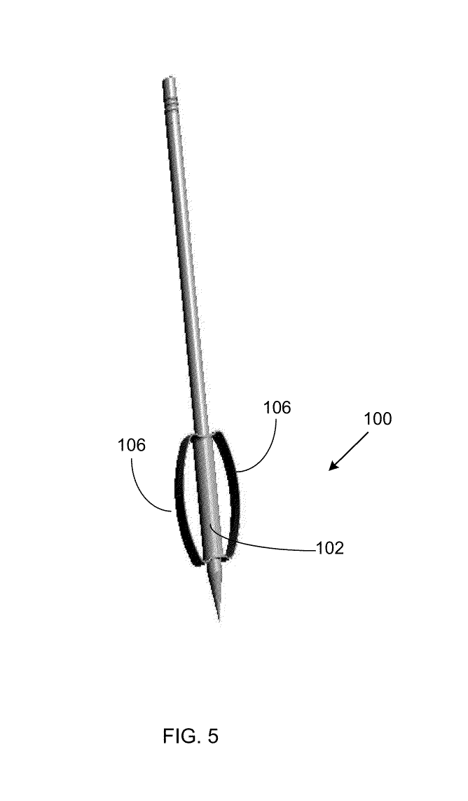

FIG. 5 illustrate a detailed perspective view of an exemplary marking enhancement device without at least one tension portion, in accordance with an embodiment of the present invention. In the present embodiment, the marking enhancement device may be configured to operate without at least one tension portion. Rather, the at least one lever may serve to provide a compressive force that counteracts the pressure applied on the marking device during marking from the grip of a hand or fingers. In some embodiments, the thickness of the at least one lever may determine each lever's strength. In this manner, a thicker, more flexible lever may eliminate the necessity of the tension portion.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing pressure attachments for marking devices to enhance writing styles according to the present invention will be apparent to those skilled in the art. Various aspects of the invention have been described above by way of illustration, and the specific embodiments disclosed are not intended to limit the invention to the particular forms disclosed. The particular implementation of the pressure attachments for marking devices to enhance writing styles may vary depending upon the particular context or application. By way of example, and not limitation, the pressure attachments for marking devices to enhance writing styles described in the foregoing were principally directed to providing adjustable counter pressure against the grip of fingers during marking implementations; however, similar techniques may instead be applied to enhancing the use of surgical devices that are pressure sensitive, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A device comprising:
a shaft portion, said shaft portion being configured to join with a marking device, said shaft portion comprising an aperture, said aperture being configured to enable at least partial passage of said marking device;
at least one lever, said at least one lever being disposed to align along a longitudinal axis of said shaft portion, said at least one lever being configured to be operable to engage a hand; and
at least one tension portion, said at least one tension portion being operable to counteract a compressive force applied to said at least one lever.

2. The device of claim 1, in which said marking device comprises a pen or pencil.

3. The device of claim 2, wherein said shaft portion covers a substantially central area of said marking device.

4. The device of claim 3, wherein said aperture is configured to form a dimension that substantially conforms to a dimension of said marking device.

5. The device of claim 4, wherein said at least one lever is configured to form a U-shape along the longitudinal axis of said shaft portion.

6. The device of claim 5, in which said at least one lever comprises two levers.

7. The device of claim 6, wherein said at least one lever is configured to be operable to support a hand.

8. The device of claim 7, in which said at least one lever comprises a compressive force, said compressive force being operable to counteract pressure applied from said hand.

9. The device of claim 8, wherein said at least one tension portion is disposed to position between said shaft portion and said at least one lever.

10. The device of claim 9, in which said at least one tension portion comprises a coil spring.

11. The device of claim 10, in which said at least one tension portion comprises two tension portions, said two tension portion being disposed to engage said at least one lever.

12. The device of claim 11, wherein said at least one tension portion exerts an outward compressive force against an inward pressure exerted by said hand.

13. The device of claim 12, wherein said device is helpful in enhancing a marking style.

14. A device comprising:
means for enabling at least partial passage of a marking device through an aperture of said device;
means for orienting said device to mark on a marking surface;
means for gripping at least one lever; and
means for counteracting pressure from a grip with at least one tension portion.

15. A marking enhancement device comprising:
a shaft portion, said shaft portion being configured to join with a marking device, said marking device comprising a pen or pencil, said shaft portion comprising an aperture, said aperture being configured to enable at least partial passage of said marking device, said aperture being configured to form a dimension that substantially conforms to a dimension of said marking device;
at least one lever, said at least one lever being disposed to align along a longitudinal axis of said shaft portion, said at least one lever comprising a U-shape, said at least one lever comprising two levers, said at least one lever being configured to be operable to engage a hand; and
at least one tension portion, said at least one lever being disposed to position between said shaft portion and said at least one lever, said at least one tension portion comprising a coil spring, said at least one tension portion being operable to counteract a compressive force applied to said at least one lever.
